(19) United States
(12) Patent Application Publication
(10) Pub. No.: US 2009/0083636 A1
(43) Pub. Date: Mar. 26, 2009

(54) User media preferences visual key display method

(75) Inventors: Michael D. Troiano, Sudbury, MA (US); J. Trent Adams, Framingham, MA (US); Scott D. Centurino, Sharon, MA (US)

Correspondence Address: LAW OFFICE OF DAVID H. JUDSON, 15950 DALLAS PARKWAY, SUITE 225, DALLAS, TX, 75248, US

(73) Assignee: MATCHMINE LLC, Needham, MA (US)

(21) Appl. No.: 11/858,376

(22) Filed: Sep. 20, 2007

(51) Int. Cl. G06F 3/048

(52) U.S. Cl. 715/747

(57) ABSTRACT

An end user media preferences “key” captures an end user's personal media interests and tastes in a unique display format that is saved locally to an end user's computer. As the end user navigates to different web sites having media discovery applications and services, he or she uses the key to facilitate a media discovery process on such sites. In this manner, the key captures, carries and controls access to the end user's personal interests and tastes across multiple sites. On a given site, the key is used (by a local media discovery platform or process) to help match video, audio or other textual content with the end user based on the preference information that has been collected and embedded in the key. Upon receiving the key, the local media discovery platform or process immediately learns what the end user likes and can then locate the movies, video, news or other content that the end user would otherwise have to locate directly or via site-specific entry and processing of end user preference data. The media preference key preferably is displayable as a sphere that comprises a plurality of zones on its surface. Preferably, each zone on the sphere represents a given media type. A user's preferences and the strength of those preferences are represented on the sphere. In particular, one or more crystal-like representations extend from each zone, preferably with each crystal representing an individual media type attribute. The height of the crystal then represents the strength of the preference.

### CROSS-REFERENCE TO RELATED APPLICATIONS

This application is related to the following commonly-owned applications:

U.S. Ser. No. 11/______, filed May ______, 2007, titled “Identifying content.”

U.S. Ser. No. 11/______, filed Aug. ______, 2007, titled “Method for storing, transporting and using user media preferences information.”

U.S. Ser. No. 11/______, filed Aug. ______, 2007, titled “Display method for generating a media preferences data structure.”

### COPYRIGHT STATEMENT

This application includes subject matter that is protected by copyright. All rights are reserved.

### BACKGROUND OF THE INVENTION

1. Technical Field

The present invention relates generally to techniques for discovering media content in an online environment.

2. Background of the Related Art

There are many types of online media including movies, music, blogs, video, books, games, other software downloads, and the like. Internet search engines can locate such online media using many well-known techniques, and these search tools are becoming more and more sophisticated and specialized. Thus, for example, Google Video enables an end user to search for a given video by keywords, language, duration, genre and other attributes. To help end users navigate through this myriad of content, many content provider web sites also offer content recommendations. In a conventional approach, a web site uses collaborative filtering to provide movie or book recommendations based on prior purchases by the end user or others who share something in common with the particular end user (e.g., an interest in action movies, or mystery novels). Web sites may also collect and maintain such preference information to facilitate the end user's browsing experience on the site.

Such information, however, is site-specific and thus useful only on the site that collects or generates that preference information. An end user that desires to present his or her preferences across multiple (typically unaffiliated sites) has no way of doing so.

### BRIEF SUMMARY OF THE INVENTION

An end user media preferences visual “key” is created according to the techniques described herein. The key is uniquely associated with a given end user, but it does not disclose personally identifying information of that user. The key captures the end user's personal media interests and tastes in a unique display format that is saved locally to an end user's computer. As the end user navigates to different web sites having media discovery applications, widgets, and web-based services, he or she uses the key to facilitate a media discovery process on such sites. In this manner, the key captures, carries and controls access to the end user's personal interests and tastes across multiple sites. On a given site, the key is used (by a local media discovery platform or process) to help match video, audio or other textual content with the end user based on the preference information that has been collected and embedded in the key. Upon receiving the key, the local media discovery platform or process immediately learns what the end user likes and can then locate the movies, video, news or other content that the end user would otherwise have to locate directly or via site-specific entry and processing of end user preference data.

The media preference key preferably is displayable as a sphere that comprises a plurality of zones on its surface. Preferably, each zone on the sphere represents a given media type (e.g., movies, music, blogs, video (non-movie), books, audio (non-music), news (general web content), or the like). A user's preferences and the strength of those preferences are represented on the sphere. In particular, one or more crystal-like representations extend from each zone, preferably with each crystal representing an individual media type attribute. Thus, for example, for the “movies” zone, a crystal may represent a particular genre, such as action movies. The height of the crystal then represents the strength of the preference. Preferably, the crystals associated with a given zone are of a same or similar color. As the end user provides more preference information via the forge, the number, configuration and/or lengths of the crystals change accordingly.

Once forged, the media preference key is saved to an end user's local computer. As the end user runs applications online, navigates to web sites, or interacts with other devices (e.g., Internet access devices, mobile phones, cable set-top boxes) that include media discovery functions, the key (in the form of a non-visual representation thereof) provides a transportable media preference profile that is used to facilitate local media discovery.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a representative computer system in which the subject matter described herein may be implemented;

FIG. 2 illustrates a movie recommendations web site (or Rich Internet Application) showing the media preference key according to the subject matter herein;

FIG. 3 illustrates a media preference key data structure formatted as XML;

FIG. 4 illustrates a media preference visual key that is generated from the data in the media preference key data structure;

FIG. 5 illustrates the components that are used to generate the visual key;

FIG. 6 illustrates a portion of the visual key showing a zone;

FIG. 7 illustrates a key forge for use in collecting end user preference data;

FIGS. 8-14 illustrate an operation of the key forge; and

FIG. 15 illustrates a representative key data structure having preference data that is collected via use of the key forge interface and that is used to build a visual key.

### DETAILED DESCRIPTION OF AN ILLUSTRATIVE EMBODIMENT

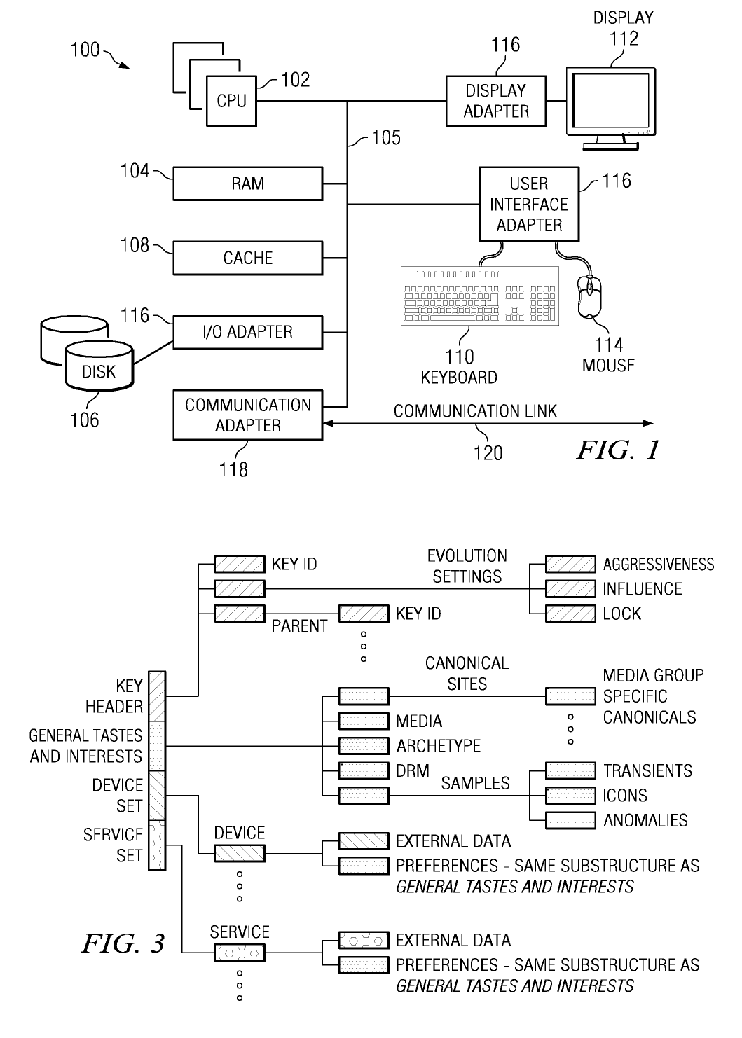

The subject matter herein provides a display method, preferably implemented as a set of processor-executable instructions in a computer. A simplified block diagram of a representative computer system in which the subject matter described herein may be implemented is shown in FIG. 1. The computer system 100 suitable for storing and/or executing program code includes at least one processor 102 coupled directly or indirectly to memory elements through a system bus 105. The memory elements can include local memory 104 employed during actual execution of the program code, bulk storage 106, and cache memories 108 that provide temporary storage of at least some program code to reduce the number of times code must be retrieved from bulk storage during execution. Input/output or I/O devices (including but not limited to keyboards 110, displays 112, pointing devices 114, etc.) can be coupled to the system either directly or through intervening I/O controllers 116. Network adapters 118 may also be coupled to the system to enable the data processing system to become coupled to other data processing systems or devices through intervening private or public networks 120.

The computer system of FIG. 1 is representative, although the subject matter herein may be implemented in any computing system or device. More generally, the data processing system is any Internet-accessible device, such as a desktop computer, notebook computer, Internet-enabled mobile device, cellular phones, cable or satellite set-top units, any other processor-driven device having a rendering engine, or the like. A representative device includes an application for accessing, viewing, downloading or otherwise retrieving media content from Internet-accessible data centers or machines that support or make available web and other content. A typical application is a web browser or browser plug-in. Preferably, that application comprises a rendering engine that is compatible with current state-of-the-art web technologies such as XHTML, XML, CSS, DOM, JSON, and the like. These technologies are sometimes referred to as “AJAX” (Asynchronous JavaScript and XML) technologies, and they include XHTML (Extensible HTML) and CSS (Cascading Style Sheets) for marking up and styling information, the use of DOM (Document Object Model) accessed with client-side scripting languages, the use of an XMLHttpRequest object (an API used by a scripting language) to transfer XML and other text data asynchronously to and from a server using HTTP), and use of XML or JSON (JavaScript Object Notation, a lightweight data interchange format) as a format to transfer data between the server and the client.

An end user accesses a web site in the usual manner, i.e., by opening a browser or other media rendering application to a URL associated with a service provider domain. The user may authenticate to the site (or some portion thereof) by entry of a username and password. The connection between the end user entity machine and the system may be private (e.g., via SSL). Although connectivity via the publicly-routed Internet is typical, the end user may connect to the system in any manner over any local area, wide area, wireless, wired, private or other dedicated network. A server-side of the connection is sometimes referred to as a web site, which is a collection of pages (typically formatted according to markup language, such as HTML) that are served by one or more machines. Depending on the site's functionality, a typical “web site” comprises infrastructure such as a front-end IP switch, one or more actual web servers for serving the content, one or more application servers, one or more administrative servers, and supporting storage devices. One or more of the site's functionality may be outsourced to third parties. A representative web server is Apache (2.0 or higher) that executes on a commodity machine (e.g., an Intel-based processor running Linux 2.4.x or higher).

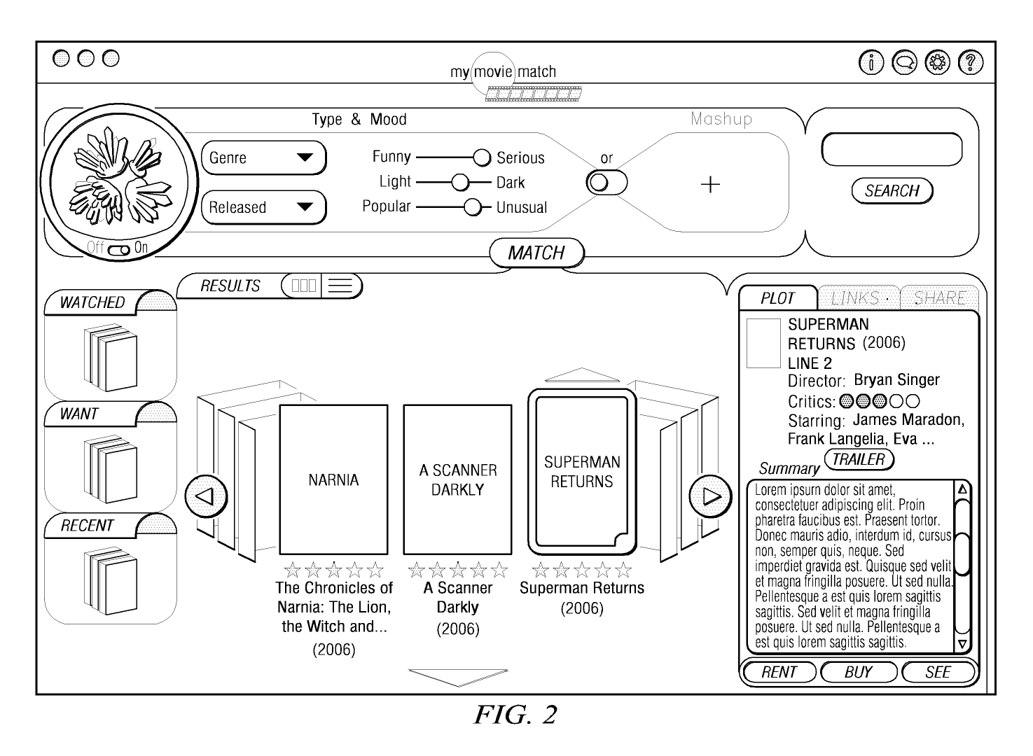

In the context of the subject matter herein, it is assumed that the web site executes a “media discovery” application. The application is executed using conventional server resources or functions, depending on the local server-side architecture. Thus, for example, the application may be a simple HTML-based web site, or the site may execute the application in an application server tier using conventional web servers for a presentation layer. The above are merely representative examples. As used herein, “media discovery” refers to any function for discovering or providing end users with recommendations concerning “media,” preferably based on the user preferences. As used herein, “media” should be broadly construed as any known or later-developed media types including, without limitation, movies, music, web logs or “blogs,” video, books, games, software downloads, and the like. Thus, as illustrated in FIG. 2, a movie recommendations web site (© 2007, Matchmine, LLC, all rights reserved) comprising a display in the form of a web page that is exported to and displayed on an end user's client machine in the usual manner. As used herein, a “site” may comprise a conventional set of pages formatted according to HTML, a Rich Internet Application (or “RIA,” which is a desktop application implemented using predominately web technologies), or the like. Although any convenient layout may be used, this particular page 200 comprises an upper portion 202, and a lower portion 204. The upper portion 202 displays a media preference visual key 206, as described in more detail below, together with a set of drop-down menus and/or radio buttons 208 by which the end user enters selection criteria. The media preference visual key 206 is displayed in a visual region 205. In the alternative to using the menus/buttons 208, the end user can toggle a control and select input criteria via a mash-up data entry widget, or via a text entry search. The media discovery application analyzes preference data in the key 206 and the search criteria, on the one hand, against the available media selections, on the other hand, and returns a set of search results/recommendations. The search results/recommendations populate the lower portion 204. In this illustrative embodiment, the lower portion displays a set of movie selections that match the user's preference and a set of selection criteria. These selections are displayed by an image rendering tool 210 that is implemented in a known manner using AJAX and related technologies. In one embodiment, image rendering tool leverage Adobe Flex™ technologies. The end user scrolls through the individual selections using the forward and back arrows. The left portion of the page includes a set of image links 212 by which the end user can view the titles that he or she has already watched, that he or she desires to see, or that were viewed recently. By selecting a given image (or the like), the user can learn additional information via a set of sub-pages 214 on the right portion of the page. These sub-pages include a Plot page (by which the end user can learn bibliographic data about the title or find where to rent, buy or see the movie), a Links page (by which the end user can locate other online information about the title), and a Share page (by which the end user can share his or her selections with others).

The media preference visual key is a display widget that captures the end user's personal tastes and interests with respect to a set of one or more media types. In a preferred embodiment, the visual key is generated from a mathematical representation of the end user's personal interests and tastes across one or more media types including, without limitation, movies, music, blogs, video (non-movie), books, audio (non-music), news (general web content, or the like). A preferred technique for creating the mathematical representation is described in commonly-owned application Ser. No. 11/______, filed May ______, 2007, titled “Identifying Content.” That application is incorporated herein by reference. Conveniently, the key (in the form of the mathematical representation) is defined as XML for flexibility and the abundance of tools designed to produce and consume XML based information. FIG. 3 illustrates this structure pictorially. As illustrated, the key data structure comprises a root element 300, together with a set of main functional groups: a header 302, general preferences 304, device specific data 306, and service specific data 308. The header group contains information about a key that uses this structure. The preference group contains general various forms of preferences. As described in Ser. No. 11/______, canonical preferences comprise a reduced set of dimensions that in combination describe content items. Canonical preferences are represented using one or more canon elements. Each canon element has one canonical vector, which is a string encoded using a preference format. In addition, each canon element has attributes that identify the media group to which the vectors apply, the evolution generation of the vectors within this group, a number of points (e.g., content ratings, manual edit steps, etc.) that contributed to the vector, and a weight of importance of this group of vectors relative to other groups of vectors of the same media group. Preferences are encoded in the key as traits. Preference traits indicate a positive or negative bias toward a particular subject. Preferably, there are two types of preference traits, canonical and media, both of which comply with the following encoding:

| | |
|---|---|
| Preference Vector: | pref[;pref]... |
| where pref is: | id,val[,[mood][,time]] |

Each preference has a required alphanumeric ID token to identify the canonical or media type and a required preference value token in the range 0.0-1.0. Optional tokens can reference a mood and/or a time of day to which the preference applies. Thus, for example, mood is expressed as an alphanumeric ID. Time is expressed as an integer from 0 to 23 indicating an hour in local 24-hour time. A simple key comprises the key header (an ID) and a set of canonical vectors that have preference information encoded therein. Preferably, vectors are bundled by media group, and each media group vector carries generation and weight attributes.

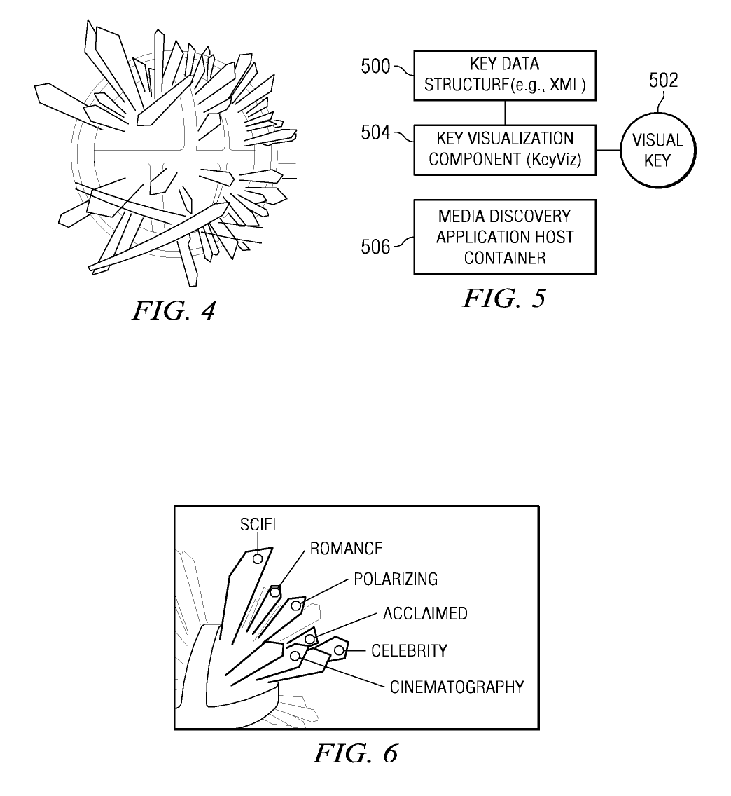

According to the subject matter herein, the preference data is used to generate a visual key, such as shown in FIG. 4, which key can be transported by the end user across one or more sites and thus used in a variety of media discovery applications, services and platforms. Referring briefly to FIG. 5, preferably key data structure 500 is converted into visual key 502 by a key visualization component 504, which executes as a process or thread in association with a media discovery application host container 506. An implementation of the key visualization component 504 is described in more detail below. Referring now back to FIG. 4, preferably the visual key is a sphere or ball 400 comprising one or more zones 402 representing media groups in the key data structure, with each media group (each zone) having one or more crystals emerging from the surface to represent various (groups of) canonical axes. A zone thus corresponds to a given surface area of the sphere. Each media group in the key data structure preferably is a zone on the visual key. Typically, any media group present in the key data structure contains at least one vector with at least one canonical axis with a valid value. As will be described in more detail below, preferably the zones are placed as sized as follows. The sphere is transected horizontally into two regions, referred to as the northern and southern regions. The media groups in the key data structure are then assigned to the regions, preferably in the same order as they appear in the key data structure, with the first assigned to the northern region, the second to the southern region, and so on. Preferably, zone placement in the northern and southern regions start at offset latitudes. The sizes of the zones can vary. Typically, the size of a zone represents a depth of interest and relative use of the corresponding media groups of the key data structure and may be determined by the relative maturity of those media groups. The maturity of each media group typically is a function of the generation and points for the canons/vectors in that media group. Once the individual zone sizes are determined, the size of each region is simply the sum of all its zones. After the zones are placed and sized, each zone is populated with zero or more crystals (projections) representing the values of one or more canonical axes for the corresponding media group. The number of crystals in a zone is determined by the available room in that zone. An algorithm for determining how to map canonical axes to each crystal is described below. Preferably, negative axis values in the key data structure are represented as divots on the visual key.

Preferably, the display of the visual key should be from a perspective that makes a maximum number of zones visible simultaneously.

FIG. 6 illustrates a portion of the visual key 600. In this example, the movies constitute the zone 602 having a set of crystals (projections) 604 of varying weights (represented as heights from the surface). The crystals represent preference attributes, and the values of these attributes are set by the end user through a display and data entry process described below. In this example, there are several different types of movie attributes: Science Fiction (SciFi), Romance, Polarizing, etc. The visual key zone represents a summary distillation of the end user's reaction to movies with these basic attributes or characteristics. Thus, for example, if the end user shows a preference for movies such as Star Wars over romantic comedies, the SciFi projection will be higher than the Romance projection. The key data structure and the associated visual key represent a distilled essence of the end user's preferences across media types, reflected in a rich set of attribute scores that typically evolve over time.

The visual key may be manipulated visually in response to direct user manipulation, e.g., change or evolution of the key data structure, or entry/exit of a pointer to the visual key. Although not meant to be limiting, preferably the visual key is rendered in color by selecting a “visualization” setting, with each media group zone colored as determined by a color mapping scheme. Alternatively, the visual key is rendered in gray-scale. Whenever the display pointer enters the visual region (such as region 205 as shown in FIG. 2) and the visualization setting is enabled, the key may appear to grow to indicate that it is aware of the user and ready to be interacted with; when the pointer leaves the region, the key shrinks back to its normal size. When the user grabs the key (e.g., by clicking on it) and the visualization is enabled, dragging within the visual region rotates the key around the corresponding visual axis, e.g., up/down causes pitching, and left/right causes yawing. A right click on the visual key may display other user-selectable options, such as saving a snapshot of the visual key, loading the visual key from local storage or other location, saving a backup of the visual key, clearing the key to some default setting, getting a new key, or the like.

Referring back to FIG. 5, the host container 506 provides the key data structure 500 to the key visualization component 504. The host container 506 is also responsible for providing a new evolution of a then-current key data structure 500, as well as controlling changes to the visualization state.

Preferably, the key data structure is populated by a visual key forge interface, as is now described. Typically, the visual key forge interface is displayable as a graphical user interface (GUI) widget, using local display resources of an end user computer. Alternatively, the interface may be exported from a web site. Whether implemented on a client-side or a server-side, this interface is used to capture media preference information from an end user, preferably in a simple intuitive manner. The forge interface is generated in any convenient manner. The functionality of the interface is best described by way of example of a typical end user interaction. In this example, it is assumed that the media discovery application is associated with a movie recommendation site; of course, this is merely exemplary and should not be taken to limit the invention.

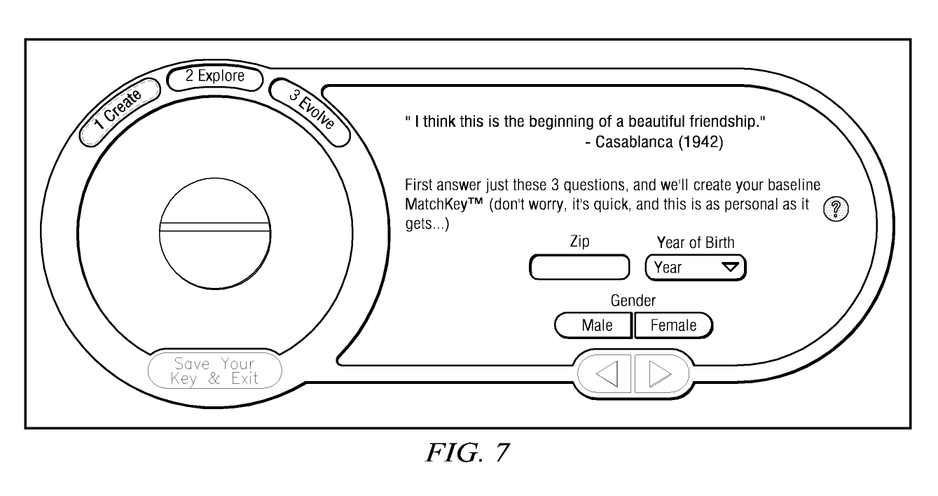

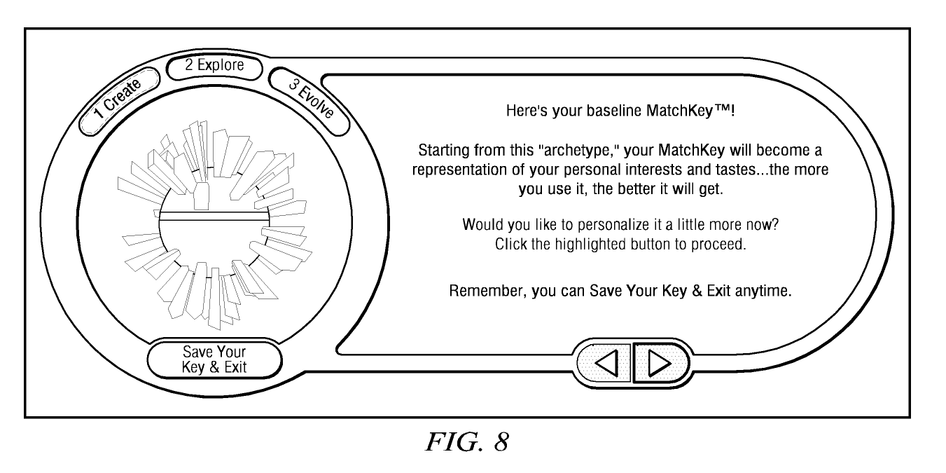

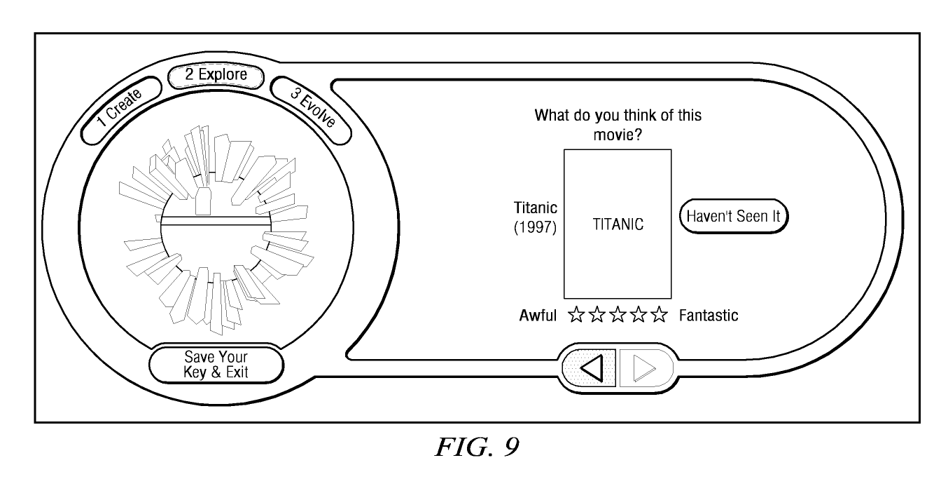

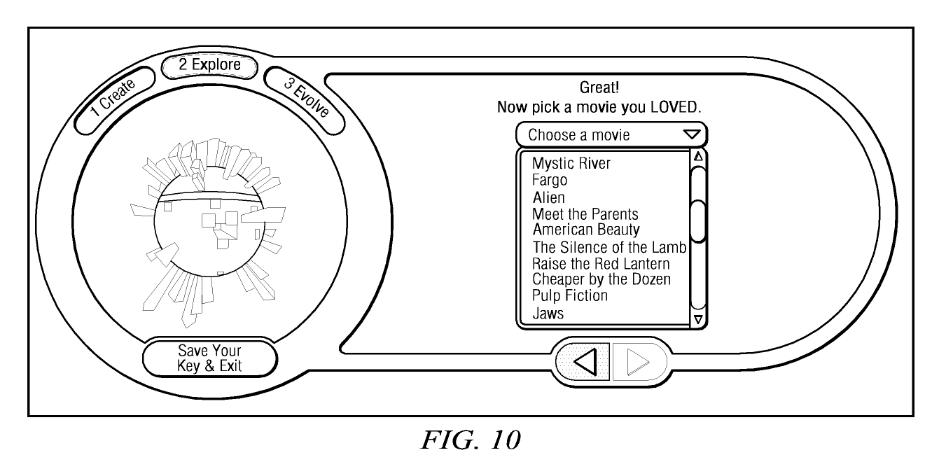

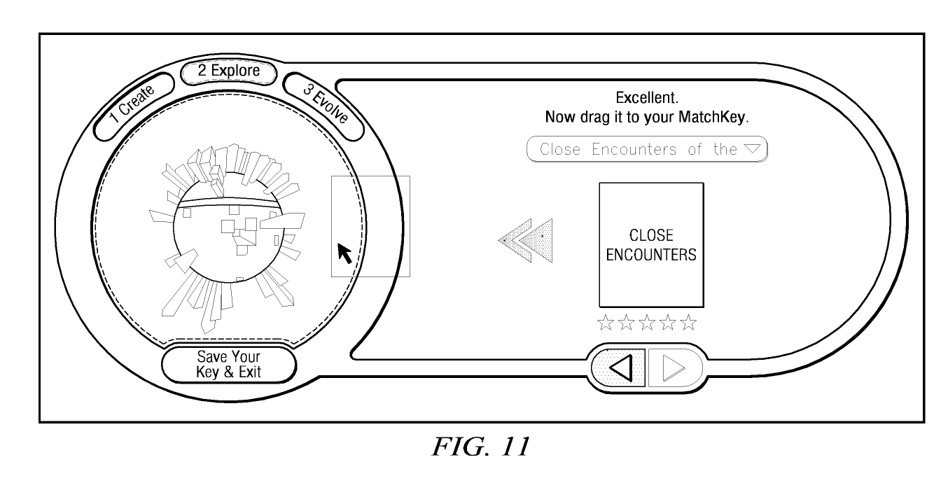

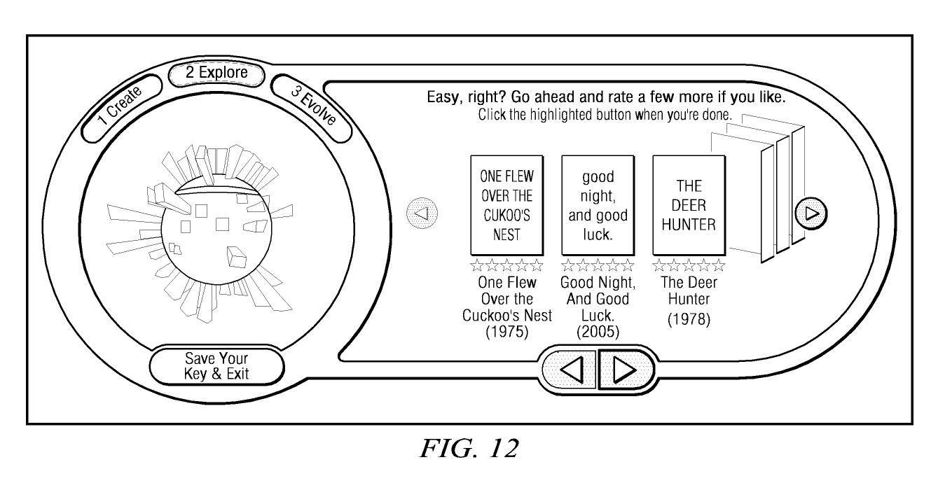

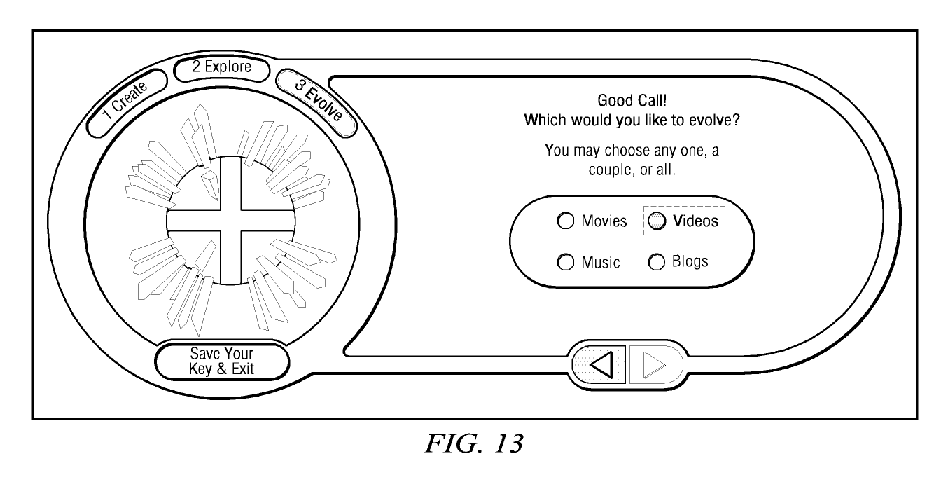

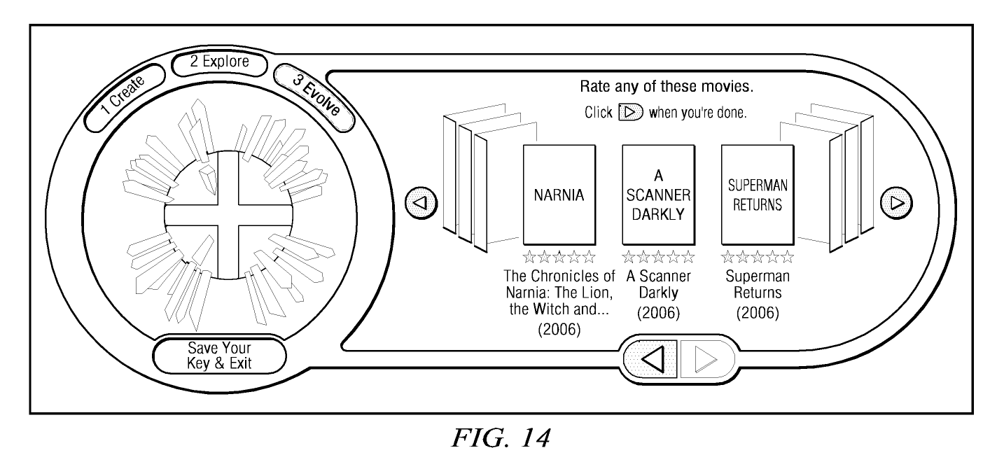

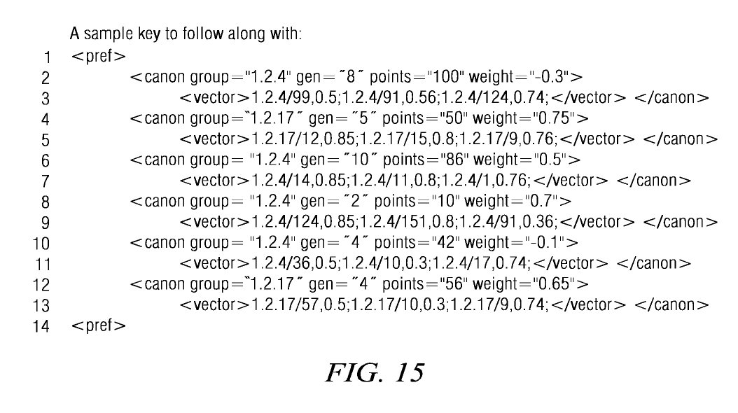

As illustrated in FIG. 7, the forge 700 has two main display portions, a first portion 702 that displays the visual key as it is being forged, and a second portion 704 that displays various controls and images. When the forge is opened and a Create button is selected, the end user is prompted to enter several pieces of information, e.g.: zip code, year of birth, and gender. Other more fine-grained demographic information may be collected, but it is desired that the forge operate without collecting personally identifiable information (PII). Once the initial questions are answered, the end user hits the forward arrow. A baseline visual key is then displayed such as shown in FIG. 8. The end user is then prompted to continue the process by selecting the Explore button. In particular, and as shown at FIG. 9, the forge displays a random movie title and the end user is prompted to provide a rating. As the end user provides a response, the system begins to collect the preference data that is used to populate the canonical vectors in the key data structure. In FIG. 10, the forge interface prompts the end user to select a favorite movie from a drop down selection list. In FIG. 11, the selected title is displayed in the forge interface and the end user is prompted to drag the image onto the visual key. As more data is collected, the zone projections are adjusted (preferably dynamically) to reflect the new or modified data. FIG. 12 illustrates another way in which the forge collects ratings information. In this panel, the forge presents a series of random movie titles that are then rated by the user. Alternatively, the end user may select the Evolve button, select a media type (FIG. 13), and enter the ratings data (FIG. 14). When the end user is finished, he or she saves the key and exits the forge. The host container then saves the key data structure and visual key to local storage. A representative key data structure is shown in FIG. 15.

Thus, according to the subject matter described, the forge interface is used to collect end user preference data via the selective display of media selections and the capture of end user responses. As media selections are displayed and rated, the host container builds the key data structure (see, e.g., FIG. 15) and controls the key visualization routine to display the visual key. The following section describes representative algorithms for the visual key rendering process. These algorithms comprise the key visualization component, and they are preferably implemented in software (e.g., a set of computer program instructions) executable in at least one processor. A representative implementation is computer program product comprising a tangible medium on which given computer code is written, stored or otherwise embedded. The computer code provides a set of display functions that are now described.

The Basic Key Visualization (KeyViz) is a component available to one or more media discovery applications. As described above, the component displays a near-unique, compelling, visually attractive “vKey” based on the likes and dislikes as represented by any key data structure (referred to herein as MKey). It also provides to the user a limited level of interaction with the visual key (vKey) to help create a relationship between a user and his/her MKey. In this context, and with respect to a KeyViz component, a media discovery application is sometimes referred to as a “Host Container” (i.e., an application that contains, among other features, the ability to present a visualized MKey).

An application that uses the KeyViz component provides a circular visual region for the KeyViz UI not smaller than a given number of display pixels in diameter and not larger than a given number of display pixels in diameter. Whenever the KeyViz visual region is visible to the user, preferably all user interactions with that region are handled by the KeyViz component. Preferably, KeyViz is a self-contained component that relies on the Host Container for interaction with information sources. If there is no MKey available for use in an application, the Host Container is responsible for soliciting the user to locate an existing MKey or launching the KeyForge to create a new one.

Whenever the KeyViz has an MKey for use, it displays the corresponding vKey, preferably based on the following rules: (1) the vKey is a sphere, with one of more zones representing the media groups in the mKey, each of which has crystals emerging from it to represent various (groups of) canonical axes; (2) each media group in the MKey becomes a zone on the vKey; (3) zones are placed and sized; (4) each zone is populated with zero or more crystals representing the values of one or more canonical axes for the corresponding media group.

### Constructing the Visualization Vectors

Each MKey contains at least one prefs element, each of which contains one or more canon elements, each of which contains exactly one vector element. The first step of visualization is to consolidate the MKey information into a single visualization vector for each Media Group represented in the key. The following is a conceptual overview of this process:
1. Locate the correct prefs element for usage in this context (based on device, application, etc.)
2. For each Media Group represented:
   a. Examine each canon element for that Media Group
      i. The “generation” of the visualization vector is the maximum “generation” value of all canon elements for that Media Group
      ii. The “points” of the visualization vector is the maximum “points” value of all canon elements for that Media Group
   b. Select the canon element of maximum positive “weight”.
      i. Copy its “vector” (exactly as it appears in the canon element) as the initial Visualization Vector
   c. Select the canon element with the maximum negative “weight” (i.e. the “most negative” “weight”)
      i. If there are no canon elements with negative weights, skip the remainder of this step
      ii. Examine each canonical axis in the “vector” element of the selected canon
         1. If the canonical axis (with value N) is not already present in the Visualization Vector, add that axis to the Visualization Vector with value (−1)*N
         2. If the canonical axis is already present in the Visualization Vector, compare its value (N) with the value already stored in the Visualization Vector (P). If N>P, then replace P with (−1)*N. Otherwise, leave it unchanged as P

### Zone Sizing

Once the Visualization Vectors have been constructed, the next step is to lay out the zones onto the sphere. To do this, the size of each zone must be calculated. The following is one approach to this sizing. It requires three passes through the list of vectors.

1. Definitions
a. For each variable V, V_{T} shall be the total of this variable across all vectors and Vₙ shall be the value of the variable for Vector n
b. P=points
c. WC=Weighted Coverage
d. G=Polygons (in addition to G_{T} and Gₙ, we also have Gₐᵥₐᵢₗ (the total number of polygons available for use on the sphere) and Gₘᵢₙ (the minimum number of polygons we are willing to use for any zone)
e. EC=Weighted Coverage available for error correction

2. Algorithm
a. First Pass
   i. Calculate P_{T} as the sum of each Pₙ
b. Second Pass
   i. For each vector Vₙ
      1. WCₙ=Pₙ/P_{T}
      2. Gₙ=Maximum (Gₘᵢₙ, Round(Gₐᵥₐᵢₗ*WCₙ))
      3. G_{T}=G_{T}+Gₙ
      4. If Gₙ>Gₘᵢₙ then EC_{T}=EC_{T}+WCₙ else WCₙ=0
      5. Keep track of the vector with the maximum polygon count (Vₘₐₓ)
c. Third Pass
   i. Prep
      1. E_{T}=G_{T}−Gₐᵥₐᵢₗ
      2. G_{T}=0
   ii. For each vector Vₙ
      1. Gₙ=Gₙ−Round(E_{T}*(WCₙ/EC_{T}))
         a. Note that in step 4 of the second pass, all zones at minimum size had their WC set to 0, so they aren't adjusted
      2. G_{T}=G_{T}+Gₙ
   iii. For vector Vₘₐₓ
      1. Gₙ=Gₙ+Gₐᵥₐᵢₗ−G_{T}
      2. This final step ensures that we end up with exactly the correct number of polygons (corrects for all rounding errors)

3. Zones are placed and sized as follows
a. The vKey sphere is transected horizontally into two regions, referred to herein as the northern and southern regions.
b. The media groups in the MKey are assigned to the regions in the same order they appear in the MKey, with the first group assigned to the northern region, the second to the southern region, and so on.
c. The size of each region is simply the sum of all its zones (because each zone size has been calculated as the required number of polygons)

### Crystal Sizing and Down-Sampling

If necessary, one or more down-sampling techniques may be used to provide a balance between crystal aesthetics and accuracy. They are broken into two categories: aggregating and sampling. Aggregating calculates a crystal height using the values of a created group of axes. Sampling selects individual axes to use for each crystal. Aggregation potentially over-smooths the vKey, eliminating uniqueness. Sampling has a disadvantage in that across an evolution, the axis to use for each crystal can change; to be valid, preferably any sampling algorithm deterministically maps axes to crystals to ensure consistency across sessions. For aggregating, Mean and Median calculations may be used. For sampling, Quartile selection may be used.

### Aggregating Category Techniques

1. Determining the groups of axes for each crystal:
1. Assume there are “n” total canonical axes in an ordered list (the order shall be the order of the axes in the mKey), and that there is room to display “d” crystals.
2. Calculate: x and y to be the integer quotient and remainder, respectively of n/d. From this, conclude y crystals are needed representing groups of x+1 axes and the rest with x axes.
3. Start at the beginning of the list of axes, grouping them accordingly. Count y groups of x+1 axes, followed by d-y groups of x axes

### 2. Determine Crystal Height (Two Possible Illustrative Methods)

1. MEAN: The height of each crystal is calculated as the arithmetic mean of all its constituent axes times the maximum crystal height. Any height calculated as negative should be displayed as a dimple or divot on the sphere.
2. MEDIAN: The height of each crystal is calculated as the median of all its constituent axes times the maximum crystal height. Any height calculated as negative should be displayed as a dimple or divot on the sphere.

### Sampling Category Technique (Quartile)

1. Sort the axes by value, from largest to smallest.
2. Determine the corresponding quartiles of the sorted list. If the number of axes is not a multiple of four, the “extra” values should be assigned, in order, to the first, third, and if necessary second quartiles.
3. For the first four crystals, use the axes with the largest values in the first, third, second, and fourth quartiles, respectively; for the next four, use the axes with the second-largest values in those quartiles, and so on. The height of each crystal is calculated as the value of the selected axis times the maximum crystal height. Any height calculated as negative should be displayed as a dimple on the sphere.

### Key Portability

Inherent in its nature and design, a user's media preference key or “key” can be used in a plurality of software programs, websites, and devices, collectively referred to as “applications,” provided those applications are properly enabled. Multiple methods exist for realizing the mechanics of such portability. The following examples are offered as illustrative and are not intended to limit the invention.

The first example focuses on applications that are accessed via a user's computer and further assumes that a user's key resides on this computer. In this example, a locally resident software program (called GateKeeper) acts as a proxy for the user in managing his/her key. Preferably, the proxy runs in the background. Applications that need access to the key gain that access through an interface to the proxy. To normalize this key access interface for both local applications and browser-based applications, preferably the proxy uses an embedded HTTP server that only accepts requests originating from the same computer. Applications, whether local or browser based, access the proxy using HTTP and a specific set of store and retrieve requests. The proxy then attempts to obtain permission from the user to access the key as requested.

As noted above, typically the proxy runs at all times when a user is logged into his/her machine. Its presence is used to indicate to MKey-enabled applications and web sites that the user on the local computer has a MKey. Applications (i.e., client applications, local widgets, web site hosted widgets, and third party web sites) that detect the running proxy request access to the user's MKey. Preferably, web-based applications do not make this request unless and until the user takes an action that indicates he or she wishes such a request to be made. Preferably, when an application requests access to the user's MKey, the application provides information about itself (and its operator). Unless there is already a matching policy in effect, the proxy informs the user of the request, including the name of the application and the operator. Prior to informing the user, the proxy checks the information provided with the request to attempt to verify it for the user. For any request, preferably the user then has the option to allow or block it. The user may also indicate whether a particular allow/block decision is temporary (i.e., for this session only) or permanent. If the decision is permanent, the proxy records a “policy” for that particular application/operator combination. Any time another request is made by the same combination, the proxy uses the policy to determine whether to grant the new request, rather than prompting the user for a decision.

Certain applications may be able to evolve a user's MKey and provide the evolved key back to the proxy. Any time a user is prompted to allow/block a MKey request that is from such an application, the user has the ability to pre-approve the synchronization of his/her MKey. If the user provides this pre-approval, then the appropriate policy is also recorded. If not, then if the application request saving the MKey, the user is prompted again as before.

Preferably, the user has the ability to review all the policies that the proxy has in effect at any time, and the ability to change or delete them.

For security purposes, preferably the proxy is restricted to process only requests made to a localhost (e.g., 127.0.0.1) loopback address. The requests to the proxy typically arrive from two sources: web sandboxed code (i.e., browser applications), which may use the JSON protocol, or local applications (that are implicitly trusted by the proxy). Each request will then be processed by the proxy and be one of the following: anonymous (requests that are processed for all requesters because they are not subject to any policies), denied (any request that the user has chosen to block, either explicitly or by policy), approved (any request that the user has chosen to allow, either explicitly of by policy), or verified (any approved request for an operator that the proxy has in turn been able to verify).

An end user navigates to an application, service or platform at which media discovery is desired to be implemented. The application, service or platform typically is associated with an entity (a “certified partner”) that can provide media discovery to end users who have keys. When a participating user navigates to a certified partner's site, preferably the user's proxy (running on the end user's local machine) verifies that the operator is certified or otherwise permitted to access and user the key. This verification may be carried out using a key manager process that executes in the partner's environment, or in some third party environment. Preferably, the proxy attempts to verify the operator information provided on a request. The key manager process may include an HTTP interface that is publicly available for use by end user proxies, and a Java interface that is only accessible by the partner's server-based software.

An alternative to the local storage approach is a centralized repository of keys that is maintained on the Internet (or in an otherwise network-accessible location) and referred to as a “key registry.” In this example, a user can access or update his/her key using common Internet tools (e.g., a browser), pointing to the URL of the key registry, and logging in using personal security credentials (e.g., username and password). Applications wishing to access a key on a user's behalf are directed to the same URL and provided with the same credentials or equivalent by the user.

As used herein, references to “key” portability use the word “key” merely as a convenient shorthand. One of ordinary skill will appreciate that what is actually portable is a non-visual representation (the MKey), with the visualization (the vKey) being consistently repeatable for any given MKey.

### Variants:

The vKey may be tilted slightly off the vertical. Whenever the KeyViz does not have a current MKey, a no-key state is displayed, which is defined as an empty visual region. Whenever an updated MKey is provided to KeyViz, it is interpreted as an evolution, and preferably the transition from the prior vKey to the new vKey is animated.

While the preferred configuration of the visual key is a sphere, this is not a limitation. The visual key may be other shapes such as a cube, an ellipsoid, an isometric landscape, or the like. It may also be a simple two-dimensional configuration, such as a circle, square, a rectangle, an ellipse, or a line graph. In such case, the configuration of the zones will vary accordingly. Of course, depending on the configuration of the key, the particular manner in which the canonicals are represented may vary as well. Thus, for example, if a cube format is used, the canonicals may be visualized as sub-zones of each surface of the cube, with the relative size of each sub-zone in proportion to the relative prominence of that canonical, or as circles drawn on each zone such that the diameter of each circle represents the value of the corresponding canonical or canonicals.

As described above, in one embodiment, a centralized repository of keys is maintained on the Internet (or in an otherwise network-accessible location) and referred to as a “key registry.” In this example, a user can access or update his/her key using common Internet tools (e.g., a browser), pointing to the URL of the key registry, and logging in using personal security credentials (e.g., username and password). Applications wishing to access a key on a user's behalf are directed to the same URL and provided with the same credentials or equivalent by the user.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

The invention can take the form of an entirely hardware embodiment, an entirely software embodiment, or an embodiment containing both hardware and software elements. In one preferred embodiment, the key visualization algorithms are implemented in software executing in one or more server machines. The invention (or portions thereof) may take the form of a computer program product accessible from a computer-usable or computer-readable medium providing program code for use by or in connection with a computer or any instruction execution system. A computer-usable or computer readable medium can be any device or apparatus that can include, store or communicate the program for use by or in connection with the instruction execution system, apparatus, or device. The medium can be an electronic, magnetic, optical, or the like. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

While given components of the system have been described separately, one of ordinary skill will appreciate that some of the functions may be combined or shared in given instructions, program sequences, code portions, and the like.

Having described our invention, what we now claim is as follows:

1. A display method associated with a media preferences data structure, comprising:
rendering a key comprising a sphere having one or more zones, wherein each zone comprises one or more projections that extend from the zone;
wherein a zone represents a media group in the media preferences data structure, and a projection represents media preference data in a canonical vector associated with the media group.

2. The display method as described in claim 1 wherein the rendering step includes:
positioning the one or more zones on the sphere; and
sizing each of the one or more zones.

3. The display method as described in claim 1 further including orienting the key so that a maximum number of zones are visible simultaneously.

4. The display method as described in claim 1 wherein at least one projection in a first zone differs in color from at least one projection in a second zone.

5. The display method as described in claim 1 wherein at least one projection in a first zone differs in height from at least one projection in a second zone.

6. The display method as described in claim 1 wherein a first projection in a first zone differs in height from a second projection in the first zone.

7. The display method as described in claim 1 further including:
enlarging the key from a first size to a second size upon a first user interaction with the key; and
returning the key from the second size back to the first size upon a second user interaction with the key.

8. The display method as described in claim 1 further including:
responsive to a change in the media preferences data structure, modifying a display characteristic of a zone.

9. The display method as described in claim 1 further including:
responsive to a change in the media preferences data structure, modifying a display characteristic of a projection.

10. The display method as described in claim 1 wherein a height of a projection represents a positive value of an end user media preference.

11. The display method as described in claim 1 wherein a zone includes a divot representing a negative value of an end user media preference.

12. A computer-readable medium having computer-executable instructions for performing the method steps of claim 1.

13. A data processing system comprising a processor, and a computer-readable medium, the computer-readable medium having processor-executable instructions for performing the method steps of claim 1.

14. A display method associated with a media preferences data structure, comprising:
rendering a key comprising a display element having one or more surface areas, wherein each surface area comprises one or more structures;
wherein a surface area represents a media group in the media preferences data structure, and a structure represents media preference data in a canonical vector associated with the media group.

15. The display method of claim 14 wherein the display element is one of: a three-dimensional configuration, and a two-dimensional configuration;
wherein the three-dimensional configuration is one of: a sphere, a cube, an ellipsoid, and an isometric landscape;
wherein the two-dimensional configuration is one of: a circle, a square, a rectangle, an ellipse, and a line graph.
